(19) United States
(12) Patent Application Publication
(10) Pub. No.: US 2005/0268117 A1
(43) Pub. Date: Dec. 1, 2005

(54) Method and system for dynamic security checking of heterogeneous database environments

(75) Inventor: Kimberly DaShawn Simon, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/855,737

(22) Filed: May 27, 2004

(51) Int. Cl. H04L 9/32; G06F 11/30; G06F 12/14

(52) U.S. Cl. 713/193

(57) ABSTRACT

A database skin allows a database administrator to configure which security checks are to be implemented, the frequency with which the security checks are to be executed, the look and feel of the output, how security violations are to be resolved, where reports are to be sent, details of each security check as it is executed, statistics or metrics to be collected, and the like. A security checker is pre-loaded with security checks that always need to be executed for databases. Pluggable security check modules may also be used. A security violations manager includes a report mechanism for reporting security violations and a resolution mechanism for resolving security violations, if possible or if instructed by the database skin. The security violations manager reports errors to an error file and sends data to be reported to a report file.

### BACKGROUND OF THE INVENTION

1. Technical Field

The present invention relates to data processing and, in particular, to security checking of database servers. Still more particularly, the present invention provides a method, apparatus, and program for dynamic security checking of heterogeneous database environments.

2. Description of Related Art

Many companies develop or use products that utilize databases. These databases often store sensitive data, such as social security numbers, medical records, financial transactions, and the like. Consequently, database administrators are confronted with maintaining security for these databases. This responsibility may become unwieldy because multiple databases may be located on multiple servers and platforms. In addition, each platform may have a different method of checking database security. Also, security modules/policies constantly change as new vulnerabilities are discovered. New security policies call for new, improved, or updated security checks.

To keep up with changes to security modules and policies, companies must keep their database administrators highly trained, which results in a significant cost to the companies. Furthermore, there is a high risk of human error, because database administrators must keep track of so many databases, security policies, interfaces, etc. Database administrators also have to know and execute the correct security checking of many varying databases in a timely and efficient manner to prevent jeopardizing credibility of products and services.

Current solutions are implemented as scripts that run security checks on a database. However, the security checking is specific to a single database. Also, the scripts only run the checks and do not support resolution of security violations. Scripts also do not easily adapt to the rapidly changing requirements of differing security models/policies or database environments and administration interfaces.

### SUMMARY OF THE INVENTION

The present invention recognizes the disadvantages of the prior art and provides a system and method for dynamic security checking of heterogeneous database environments. A database skin allows a database administrator to configure which security checks are to be implemented, the frequency with which the security checks are to be executed, the look and feel of the output, how security violations are to be resolved, where reports are to be sent, details of each security check as it is executed, statistics or metrics to be collected, and the like. A security checker is pre-loaded with security checks that always need to be executed for databases. Pluggable security check modules may also be used. A security violations manager includes a report mechanism for reporting security violations and a resolution mechanism for resolving security violations, if possible or if instructed by the database skin. The security violations manager reports errors to an error file and sends data to be reported to a report file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram of a security mechanism in accordance with a preferred embodiment of the present invention; and

FIG. 5 is a flowchart illustrating the operation of a security mechanism in accordance with an exemplary embodiment of the present invention.

### DETAILED DESCRIPTION OF THE PREFERRED EMBODIMENT

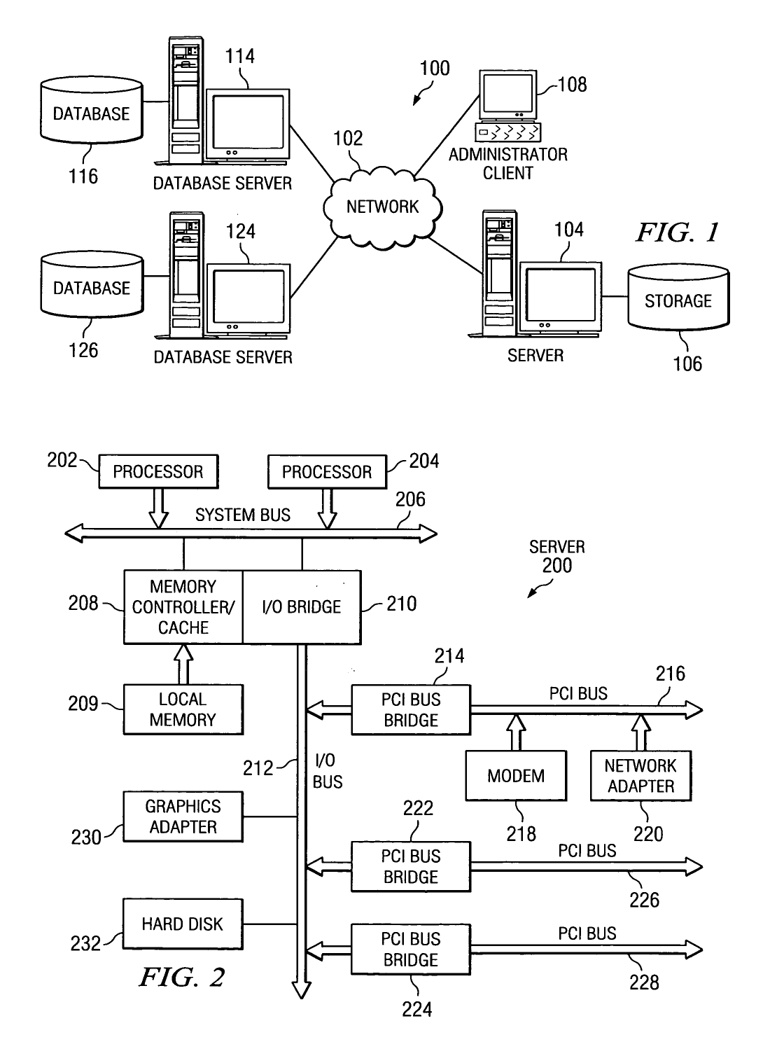

The present invention provides a method, apparatus and computer program product for dynamic security checking of heterogeneous database environments. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104, 114, 124 are connected to network 102 and provide access to storage units 106, 116, 126. In addition, client 108 is connected to network 102. Client 108 may be, for example, a personal computer or network computer. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

More particularly, in the example shown in FIG. 1, servers 114, 124 are database servers and provide access to databases 116, 126, respectively. Client 108 is a database administrator workstation. In this case, the database administrator must manage the security of multiple databases, which may have different security policies and administration interfaces. Because of this complexity, security breaches on databases are more apt to occur. This may eventually place a company's reputation and credibility, as well as profitability, at risk.

Security models/policies constantly evolve as new security holes arise. This causes database administrators to scramble to apply new or updated security checks, which are usually executed manually, to cover the new requirements of the security policies. Also, there is typically a short period of time to apply these new requirements in order to protect databases from potential security breaches. Due to the urgency and complexity of this process, particularly with heterogeneous database environments, database administrators can easily fall short of ensuring the security of the databases, causing sensitive data to be at risk.

In accordance with exemplary aspects of the present invention, a security mechanism is provided for flexible, automatic, thorough, and consistent security checking and vulnerability resolution in a heterogeneous database environment. The mechanism may be configured to run security checks on any type of database and any number of databases. The mechanism discovers and reports security violations and resolves violations, if possible. The mechanism also provides a single administration interface, which allows a database administrator to add new security checks on the fly and to configure the entire security checking process for all databases.

In an exemplary embodiment, the security mechanism may be embodied on a server, such as server 104. Report data, error information, and the like may be stored in storage 106. A database administrator may configure the security mechanism locally or remotely using administrator client 108. The security mechanism may also be configured to send output to a display, to a report file, or to a remote device, such as administrator workstation 108. In an alternative embodiment, the security mechanism may be embodied on the administrator workstation itself.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM eServer™ pSeries® system, a product of International Business Machines Corporation in Armonk, N.Y., running the Advanced Interactive Executive (AIX) operating system or LINUX operating system. An object oriented programming system, such as a Java™ programming system, may run in conjunction with the operating system and provides calls to the operating system from Java programs or applications executing on data processing system 300. “JAVA” is a trademark of Sun Microsystems, Inc.

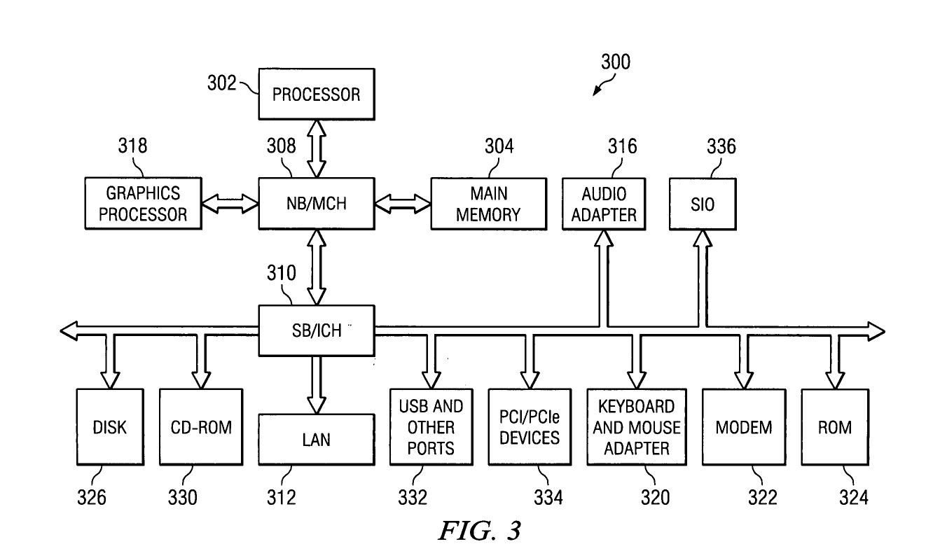

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system such as Java may run in conjunction with the operating system and provides calls to the operating system from Java programs or applications executing on data processing system 300. “JAVA” is a trademark of Sun Microsystems, Inc. Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

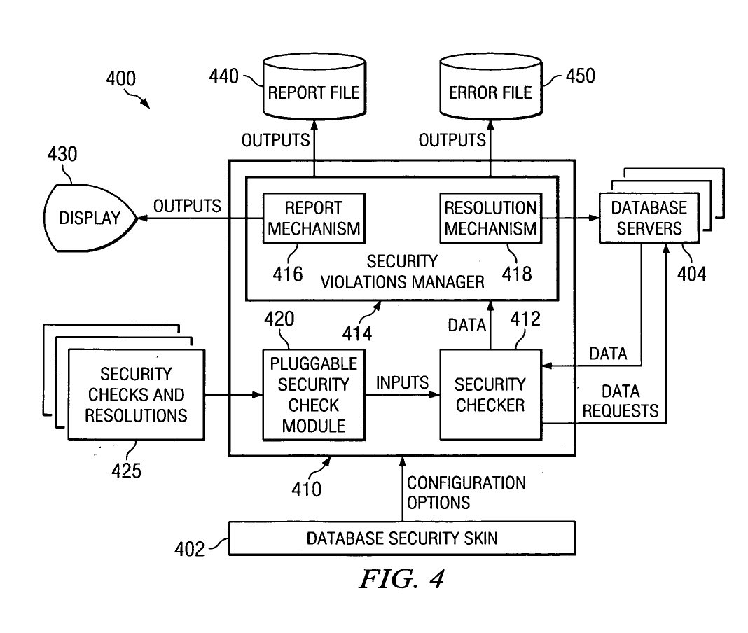

FIG. 4 is a block diagram of a security mechanism in accordance with a preferred embodiment of the present invention. Database security skin 402 is provided to security mechanism 410. Database security skin 402 allows the database administrator to configure settings for the security mechanism. For example, database security skin 402 allows the database administrator to configure which security checks are to be implemented, the frequency with which the security checks are to be executed, the look and feel of the output, how security violations are to be resolved, where reports are to be sent, details of each security check as it is executed, statistics or metrics to be collected, and the like.

Database security skin 402 may simply be provided as a text-based configuration file, although a person of ordinary skill in the art will recognize that database security skin 402 may also be provided as other data structures, such as extensible markup language (XML) files, databases, tables, and the like. Alternatively, security mechanism 410 may include or communicate with a graphical user interface (not shown) that may be used to create database security skin 402. For example, database security skin 402 may be created using a Web-based user interface (not shown).

Reports and errors may be presented on a display, for example, or may be transmitted through a messaging delivery system, such as electronic mail, for example. Statistics or metrics may include the number of violations, the causes of violations, how secure a database server is, and so forth. Therefore, the database security skin allows the database administrator to completely tailor the entire process of how databases are checked.

Security mechanism 410 includes security checker 412, which is pre-loaded with security checks that always need to be executed for databases. Security checker 412 runs the security checks against one or more database servers 404. Security checker 412 sends data requests to database servers 404, receives data from database servers 404, and is able to interpret the security checks in any programming language. The database administrator may update existing security checks as needed.

The database administrator may use pluggable security check module 420 to supplement security checker 412 with additional security checks and resolutions 425 on the fly. The database administrator or other developer may program the additional security checks and resolutions 425 in any programming language as long as they conform to an application programming interface (API) of pluggable security check module 420. This is useful as security policies evolve with new or updated security checks. The additional security checks and resolutions 425 are inserted in security checker 412 and executed along with the pre-loaded security checks. Any number of security checks and associated resolutions may be added to security checker 412 via pluggable module 420.

Security violations manager 414 includes report mechanism 416 and resolution manager 418. Security violations manager 414 controls how reporting of security violations and resolutions to those violations are handled. Data about security violations are received from security checker 412.

Report mechanism 416 handles the reporting of security violations. These violations may be stored to report file 440. Reports may also be made to display 430, which may be a terminal display or a remote device. Report mechanism 416 may send violation information via a messaging system, such as electronic mail (e-mail) or the like. For example, report mechanism may send report message indicating discovered security violations to the database administrator's mobile telephone device, PDA, text pager, or the like.

The database administrator may configure report mechanism 416 to report additional information like security checks that pass, as well as background information of the security policy from which each check originated, how to resolve the violations, etc. Thus, report mechanism 416 provides concrete evidence of how secure one or more database servers are.

Resolution mechanism 418 determines how security checks may be resolved. The database administrator may use database security skin 402 to instruct the resolution mechanism as to which security violations are to be automatically resolved and how the violations are to be resolved. For example, if a security violation reveals that certain user identifications (IDs) need to be removed from a database access list, resolution mechanism 418 may automatically remove these user IDs for the database administrator, only report the violation, suspend database activity, page or e-mail the database administrator, etc. If resolution mechanism 418 is unable to resolve the violation, it may immediately contact the database administrator and make recommendations to the database administrator on how to resolve the violation, for example.

Security violations manager 414 reports any errors that occur during execution to error file 450. Security violations manager 414 also sends data to be reported to report file 440. Database servers 404 may be of any type or configuration. For example, database servers 404 may include servers running different operating systems.

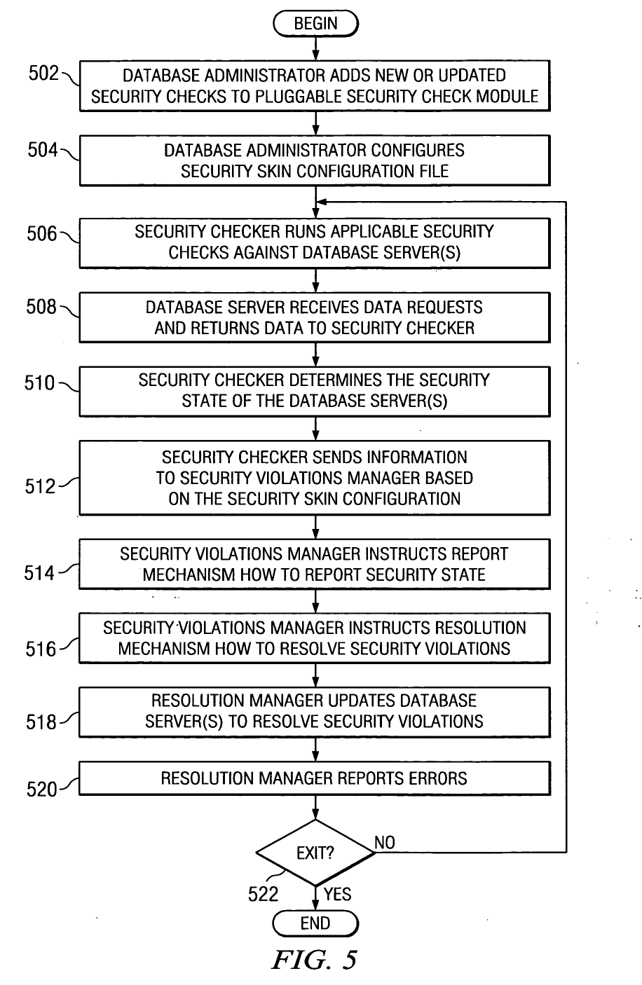

FIG. 5 is a flowchart illustrating the operation of a security mechanism in accordance with an exemplary embodiment of the present invention. Operation begins and the database administrator adds new or updated security checks to the pluggable security check module (block 502). The database administrator then configures a security skin configuration file (block 504). The database skin may allow the database administrator to configure, for example, which security checks are to be implemented, the frequency with which the security checks are to be executed, the look and feel of the output, how security violations are to be resolved, where reports are to be sent, details of each security check as it is executed, statistics or metrics to be collected, and the like.

Next, a security checker runs the applicable security checks against the database server or servers (block 506). The database servers receive data requests from the security checker and, in response, return data to the security checker (block 508). The security checker then determines the security state of the database servers (block 510).

Thereafter, the security checker sends information to a security violations manager based on the security skin configuration (block 512). The security violations manager instructs a report mechanism how to report the security state (block 514) and instructs a resolution manager how to resolve security violations (block 516), as configured by the database security skin. The resolution manager updates the database servers to resolve security violations (block 518), if necessary and if instructed by the database security skin. The resolution manager also reports any errors that may occur (block 520).

Next, a determination is made as to whether an exit condition exists (block 522). An exit condition may exist, for example, if the security mechanism is terminated or if the database security skin is configured to only run a single set of security checks. If an exit condition exists, operation ends. If, however, an exit condition does not exist in block 522, operation returns to block 506 and the security checker runs the applicable security checks again. Operation in blocks 506-520 may continue to repeat based upon an interval or frequency defined by the database security skin.

Thus, the present invention provides a security mechanism for flexible, automatic, thorough, and consistent security checking and vulnerability resolution in a heterogeneous database environment. The mechanism may be configured to run security checks on any type of database and any number of databases. The mechanism discovers and reports security violations and resolves violations, if possible. The mechanism also provides a single administration interface, which allows a database administrator to add new security checks on the fly and to configure the entire security checking process for all databases.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for security checking in a database environment having multiple heterogeneous database servers, the method comprising:
receiving first configuration information and second configuration information from a database security skin, wherein the first configuration information identifies a first set of one or more security checks to be run against a first database server within the multiple heterogeneous database servers and wherein the second configuration information identifies a second set of one or more security checks to be run against a second database server within the multiple heterogeneous database servers;
running the first set of one ore more security checks against the first database server based on the first configuration information;
running the second set of one or more security checks against the second database server based on the second configuration information; and
determining a security state for the first database server and the second database server.

2. The method of claim 1, wherein running the first set of one or more security checks includes:
sending data requests to the first database server; and
receiving return data from the first database server.

3. The method of claim 1, wherein a given security check within the first set of one or more security checks is added through a pluggable security check module.

4. The method of claim 1, wherein the database security skin includes instructions for how to report security state information.

5. The method of claim 4, wherein the instructions for how to report security state information include instructions for sending security state information to a remote device.

6. The method of claim 4, wherein the instructions for how to report security state information include statistics or metrics to be collected.

7. The method of claim 1, wherein determining a security state includes identifying at least one security violation.

8. The method of claim 7, wherein the database security skin includes instructions for how to resolve the at least one security violation.

9. The method of claim 1, wherein the first configuration information identifies a frequency with which the set of one or more security checks is to be executed.

10. The method of claim 1, further comprising:
reporting errors that occur during execution to an error file.

11. An apparatus for security checking in a database environment, the apparatus comprising:
a database security skin that includes first configuration information and second configuration information from a database security skin, wherein the first configuration information identifies a first set of one or more security checks to be run against a first database server within the multiple heterogeneous database servers and wherein the second configuration information identifies a second set of one or more security checks to be run against a second database server within the multiple heterogeneous database servers; and
a security mechanism, wherein the security mechanism receives the database security skin, runs the first set of one or more security checks against the first database server based on the first configuration information, runs the second set of one or more security checks against the second database server based on the second configuration information, and determines a security state for the first database server and the second database server.

12. The apparatus of claim 11, wherein the security mechanism runs the first set of one or more security checks by sending data requests to the first database server and receiving return data from the first database server.

13. The apparatus of claim 11, wherein the security mechanism includes a pluggable security check module and wherein a given security check within the first set of one or more security checks is added through the pluggable security check module.

14. The apparatus of claim 11, wherein the database security skin includes instructions for how to report security state information.

15. The apparatus of claim 14, wherein the security mechanism sends security state information to a remote device based on the instructions for how to report security state information.

16. The apparatus of claim 14, wherein the instructions for how to report security state information include statistics or metrics to be collected.

17. The apparatus of claim 11, wherein the security mechanism identifies at least one security violation.

18. The apparatus of claim 17, wherein the database security skin includes instructions for how to resolve the at least one security violation.

19. The apparatus of claim 11, wherein the database security skin identifies a frequency with which the at least one security check is to be executed.

20. A computer program product, in a computer readable medium, for security checking in a database environment, the computer program product comprising:
instructions for receiving first configuration information and second configuration information from a database security skin, wherein the first configuration information identifies a first set of one or more security checks to be run against a first database server within the multiple heterogeneous database servers and wherein the second configuration information identifies a second set of one or more security checks to be run against a second database server within the multiple heterogeneous database servers;
instructions for running the first set of one ore more security checks against the first database server based on the first configuration information;
instructions for running the second set of one or more security checks against the second database server based on the second configuration information; and
instructions for determining a security state for the first database server and the second database server.
